(19) United States
(12) Patent Application Publication
(10) Pub. No.: US 2010/0332898 A1
(43) Pub. Date: Dec. 30, 2010

(54) NONVOLATILE MEMORY DEVICE AND COPYBACK PROGRAM METHOD THEREOF

(75) Inventor: Byoung In JOO, Seoul (KR)

Correspondence Address: William Park & Associates LTD., 930 N. York Road, Suite 201, Hinsdale, IL, 60521, US

(73) Assignee: HYNIX SEMICONDUCTOR INC., Icheon-si (KR)

(21) Appl. No.: 12/826,545

(22) Filed: Jun. 29, 2010

(30) Foreign Application Priority Data
Jun. 29, 2009 (KR) 10-2009-0058481

(51) Int. Cl. G06F 12/16; G06F 11/14

(52) U.S. Cl. 714/15; 711/162; 711/E12.103; 714/E11.119

(57) ABSTRACT

A nonvolatile memory device includes a plurality of memory blocks each configured to include a plurality of pages, a plurality of page buffers configured to correspond to the plurality of memory blocks and send copyback data, a controller configured to send the copyback data to a page buffer selected from among the page buffers, and a register configured to store an address of a page that has been failed, from among the pages, during a copyback program operation.

### CROSS-REFERENCE TO RELATED APPLICATION

Priority to Korean patent application number 10-2009-0058481 filed on Jun. 29, 2009, the entire disclosure of which is incorporated by reference herein, is claimed.

### BACKGROUND

Exemplary embodiments relate generally to a nonvolatile memory device and a copyback program method thereof, and more particularly to a nonvolatile memory device and a copyback program method thereof, in which copyback program operations are automatically and sequentially performed without a user control.

Electrically programmable and erasable nonvolatile memory devices which do not require the refresh function of rewriting data at specific intervals are in demand.

In a nonvolatile memory device, a plurality of memory cells forms one string, and a plurality of the strings forms one memory cell array. A memory cell operates depending on the threshold voltage levels having two kinds of states, which define program and erase areas on the basis of the threshold voltages.

For example, assuming that 0 V is a reference voltage, the program and erase operations are performed according to the threshold voltage levels having two states (i.e., two states on both sides on the basis of 0 V). Such a method is called a single level cell (hereinafter referred to as SLC) method. The SLC method is excellent in the accuracy of the data storage capability because only the two states are determined on the basis of the reference voltage but problematic when processing a large amount of data.

To resolve the problem, a multi-level cell (hereinafter referred to as MLC) method was introduced. The MLC has the same physical structure as the SLC but differs logically in that MLC has threshold voltage levels having at least four states. That is, in the MLC method, a program area and an erase area are included on the basis of a reference voltage, but at least three kinds of different threshold voltage levels are defined in the program area. The MLC can process a large amount of data, because it has the same physical structure as the SLC but can drive at least four kinds of data states. That is, the nonvolatile memory device using the MLC method supports a method of storing two pieces of data in one memory cell. A driving method according to bias conditions, a distribution of the threshold voltage of a memory cell, etc. in the nonvolatile memory device using the MLC method is more complicated than a driving method of the nonvolatile memory device using the SLC method.

A copyback program method is widely used during the program method of a nonvolatile memory device. The copyback program method is performed by reading data stored in the pages of a memory cell array on a page basis, storing the read data in a page buffer, and programming the stored data of the page buffer to another page. That is, in the copyback program method, data is moved between pages through an internal operation without a process of outputting data to an external data I/O pin under specific conditions. If there is no algorithm for the copyback operation, there is a need for a method of detecting data using the page buffer, outputting the read data outside a chip, storing the output data, and then storing the data in a memory cell. Alternatively, if there is no additional depository within the chip other than the page buffer, the data has to be read outside the chip and then stored.

In the known copyback program method of the nonvolatile memory device, however, if a problem occurs during a normal program operation, a program status fail check has to be performed in response to a user's command in order to check fail, and copyback read and copyback program commands have to be newly inputted in order to move all pieces of data programmed into a fail block to another block.

### BRIEF SUMMARY

Exemplary embodiments relate to a nonvolatile memory device and a copyback program method thereof, in which a program status fail check, a copyback read operation, and a copyback program operation are automatically and sequentially performed within the nonvolatile memory device when a problem is generated in a selected memory block during a program operation.

A nonvolatile memory device according to an aspect of the present disclosure comprises a plurality of memory blocks each configured to comprise a plurality of pages, a plurality of page buffers configured to correspond to the plurality of memory blocks and send copyback data, a controller configured to send the copyback data to a page buffer selected from among the plurality of page buffers, and a register configured to store an address of a page that has been failed, from among the plurality of pages, during a copyback program operation.

The controller receives copyback data stored in a fail memory block including the fail page, from among the memory blocks, and sends the copyback data to a page buffer corresponding to a new memory block having an address greater than an address of the fail memory block, from among the plurality of memory blocks.

A copyback program method of a nonvolatile memory device according to an aspect of the present disclosure comprises storing the address of a fail page included in a memory block that has been failed during a normal program operation, from among a plurality of memory blocks, in a register, resetting the address of a page, stored during the normal program operation, to a first address, reading copyback data programmed into a page corresponding to the first address of the fail memory block, wherein the first page address is a selected address, programming the copyback data into a page corresponding to the first address of a normal memory block other than the fail memory block, increasing the first address so that the first address becomes a second address, comparing the second address and the address of the fail page, if, as a result of the comparison, the second address differs from the address of the fail page, setting the second page address as the selected address and again performing the steps subsequent to resetting an address of a page, stored during the normal program operation, to a first address, and if, as a result of the comparison, the second address is identical with the address of the fail page, terminating a copyback program operation.

The copyback program method further comprises terminating the copyback program operation if the fail memory block is a last memory block of the memory blocks and the normal program operation is determined to be error, after storing the address of the fail page in the register.

The normal memory block is selected by increasing the first address of the fail memory block by 1.

The copyback program method of claim 3, further comprising, after programming the copyback data, performing a status check operation on the normal memory block and, if, as a result of the status check operation, the normal memory block is determined to be a failure, terminating a copyback program operation.

The copyback program operation is automatically performed by an internal algorithm without an external command.

### BRIEF DESCRIPTION OF THE DRAWINGS

FIG. 1 shows the construction of a nonvolatile memory device according to an embodiment of this disclosure; and

FIG. 2 is a flowchart illustrating a copyback program operation of the nonvolatile memory device according to an embodiment of this disclosure.

### DESCRIPTION OF EMBODIMENTS

Hereinafter, some exemplary embodiments of the present disclosure will be described in detail with reference to the accompanying drawings. The figures are provided to allow those having ordinary skill in the art to understand the scope of the embodiments of the disclosure.

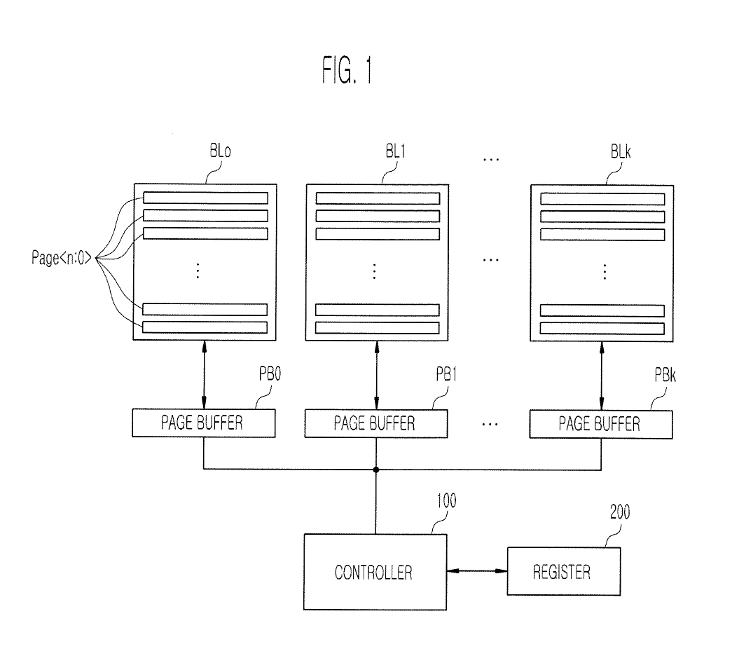

FIG. 1 shows the construction of a nonvolatile memory device according to an embodiment of this disclosure.

Referring to FIG. 1, the nonvolatile memory device includes a plurality of memory blocks BL0 to BLk each including a plurality of pages Page<n:0>, a plurality of page buffers PB0 to PBk corresponding to the respective memory blocks BL0 to BLk, a controller 100 controlling the page buffers PB0 to PBk, and a register 200 storing an address of a copyback program.

The memory blocks BL0 to BLk have the same construction, and each of the memory blocks BL0 to BLk includes a plurality of memory cells. The memory cells are classified into pages each including a plurality of memory cells. The nonvolatile memory device performs a program operation on a page basis and a read operation on a page basis.

Each of the page buffers PB0 to PBk corresponding to the respective memory blocks BL0 to BLk performs a program operation by sending program data to a corresponding memory block. Further, the page buffer reads data and copyback data by detecting a corresponding memory block.

The controller 100 sends program data to the page buffers PB0 to PBk during a program operation and receives read data detected by the page buffers PB0 to PBk during a read operation. Further, the controller 100 temporarily stores copyback data detected by a selected memory block during a copyback program operation and sends the copyback data to another memory block.

The register 200 stores the page address of a selected memory block during a copyback program operation.

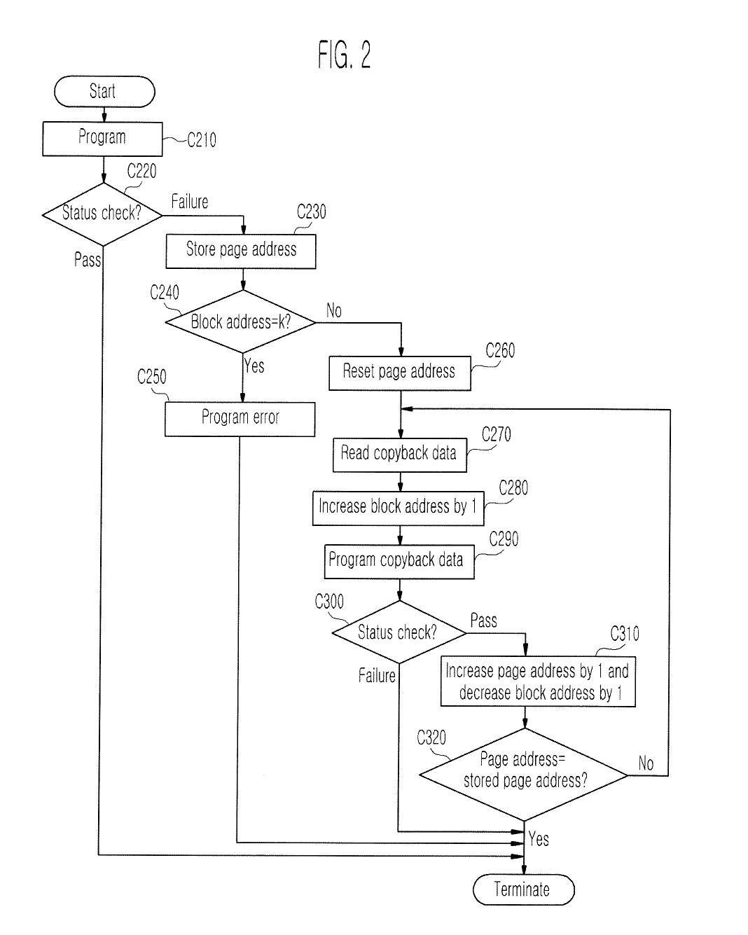

FIG. 2 is a flowchart illustrating a copyback program operation of the nonvolatile memory device according to an embodiment of this disclosure.

The copyback program operation according to an embodiment of this disclosure is described below with reference to FIGS. 1 and 2.

1) Perform Program Operation at C210

Externally inputted program data is inputted to a page buffer (e.g., PB0) selected from among the page buffers PB0 to PBk under the control of the controller 100. The page buffer PB0 temporarily stores the program data and sends it to a corresponding memory block BL0. Here, a normal program operation is performed by supplying a program voltage to the word line of a page (e.g., Page<n-2>) selected from among the pages Page<n:0> of the memory block BL0.

2) Perform Status Check Operation in a Normal Program Operation at C220

After the normal program operation, a verification operation is performed in order to check whether the program operation is a pass. That is, the verification operation is performed on the selected page Page<n-2> in order to determine whether the normal program operation has been successfully performed by comparing the program data and verification data. Here, the number of fail bits, which are generated when the program data differs from the verification data (i.e., when the normal program operation is failed), is counted. If the number of counted fail bits is greater than the number of error correction codes (ECC), the program operation is determined to be a failure. However, if the number of counted fail bits is the number of error correction codes (ECC) or less, the program operation is determined to be a pass. When the program operation is determined to be a pass, the program operation and the verification operation are terminated.

3) Store Page Address at C230

When the program operation is determined to be a failure at step C220, an address of the page Page<n-2> is stored in the register 200.

4) Check Block Address at C240

An address of the selected memory block BL0 on which the normal program operation has been performed is checked. That is, it is determined whether the selected memory block BL0 is the last memory block BLk from among the memory blocks BL0 to BLk.

5) Determine Program Error at C250

If, as a result of the determination at step C240, the selected memory block BL0 is determined to be the last memory block BLk, the program operation is determined to be error because there is no memory block to which copyback data can be moved for a program operation, and the program operation and the verification operation are terminated.

6) Reset Page Address at C260

If, as a result of the determination at step C240, the selected memory block BL0 is determined not to be the last memory block BLk, the address of the selected page (e.g., Page<n-2>) stored in the controller 100 is deleted. That is, the address of a page stored in the controller 100 is reset to Page<0>.

7) Read Copyback Data at C270

The program data stored in the selected memory block BL0 is read using the page buffer PB0. The read program data is stored in the controller 100 as copyback data.

8) Increase Block Address at C280

An address of the memory block BL1, increased by 1 from the address of the memory block BL0, is stored.

9) Program Copyback Data at C290

The copyback data stored in the controller 100 is sent to the page buffer PB1 corresponding to the memory block BL1, and the copyback data is then reset and programmed into the selected page Page<0>.

10) Perform Copyback Data Program Status Check C300

After the program operation for the copyback data, a verification operation is performed in order to check whether the program operation is normal. If, as a result of the check, the program data differs from the copyback data (i.e., in the case in which the program operation for the copyback data is failed), the program operation for the copyback data is determined to be a failure. However, if, as a result of the check, the program data is identical to the copyback data, the program operation for the copyback data is determined to be a pass. When the program operation for the copyback data is determined to be a failure, the program operation and the verification operation are terminated because the selected memory block BL0 and the memory block BL1 on which the copyback program operation has been performed are all failed.

11) Control Page Address and Block Address at C310

If, as a result of the check at step C300, the program operation for the copyback data is determined to be a pass, an address of the selected page Page<0> is increased by 1 and stored as an address of a new page Page<1>. Next, the address of the memory block BL1 is reduced by 1. That is, an address of the memory block BL0 is stored.

12) Check Page Address at C320

It is then determined whether the address of the new page Page<1> is identical with the address of the page Page<n-2> stored at step C230. If, as a result of the determination, the address of the new page Page<1> is determined not to be identical with that of the page Page<n-2>, the process returns to step C270 in which the copyback data is read.

More particularly, the address of the page Page<0> is increased by 1, and the copyback data stored in the page Page<1> of the memory block BL0 is read. The read copyback data is stored in the page Page<1> of the memory block BL1. It is then determined whether the copyback data program status is a pass at step C300. If, as a result of the determination, the copyback data program status is determined to be a pass, an address of the page Page<1> is increased and stored as the address of a new page Page<2>.

The above operation is repeatedly performed until the address of the new page Page<2> is identical with that of the page Page<n-2> stored in the register 200. That is, a copyback data program operation is performed in order to program copyback data, corresponding to a page Page<0:n-3> on which a program operation has been performed earlier than the page Page<n-2> in which a problem has occurred in the normal program operation, into the page Page<0:n-3> of the new memory block BL1>.

The above-described copyback program operation preferably is performed automatically and sequentially according to an algorithm built in a memory device without user's external command, unlike the known technique.

In accordance with an embodiments of this disclosure, when a problem occurs in a selected memory block during a program operation, a program status fail check, a copyback read operation, and a copyback program operation are automatically and sequentially performed within the nonvolatile memory device. Accordingly, a user's convenience can be improved.

What is claimed is:

1. A nonvolatile memory device, comprising:
a plurality of memory blocks each configured to comprise a plurality of pages;
a plurality of page buffers configured to correspond to the plurality of memory blocks and send copyback data;
a controller configured to send the copyback data to a page buffer selected from among the plurality of page buffers; and
a register configured to store an address of a page that has failed among the plurality of pages during a copyback program operation.

2. The nonvolatile memory device of claim 1, wherein the controller receives copyback data stored in a fail memory block including the fail page among the plurality of memory blocks, and sends the copyback data to a page buffer corresponding to a new memory block having an address greater than an address of the fail memory block among the plurality of memory blocks.

3. A copyback program method of a nonvolatile memory device, the method comprising:
storing an address of a fail page included in a memory block among a plurality of memory blocks in a register, wherein the fail page is a page that has failed during a normal program operation;
resetting an address of a page stored during the normal program operation to a first address;
reading copyback data programmed into a page corresponding to the first address of the fail memory block, wherein the first page address is a selected address;
programming the copyback data into a page corresponding to the first address of a normal memory block other than the fail memory block;
increasing the first address so that the first address becomes a second address;
comparing the second address and the address of the fail page;
if, as a result of the comparison, the second address differs from the address of the fail page, setting the second page address as the selected address and again performing the steps subsequent to resetting an address of a page stored during the normal program operation to a first address; and
if, as a result of the comparison, the second address is identical to the address of the fail page, terminating a copyback program operation.

4. The copyback program method of claim 3, further comprising terminating the copyback program operation if the fail memory block is a last memory block of the memory blocks and if the normal program operation is determined to be in error, after storing the address of the fail page in the register.

5. The copyback program method of claim 3, wherein the normal memory block is selected by increasing the first address of the fail memory block by 1.

6. The copyback program method of claim 3, further comprising, after programming the copyback data, performing a status check operation on the normal memory block and, if, as a result of the status check operation, the normal memory block is determined to be a failure, terminating a copyback program operation.

7. The copyback program method of claim 3, wherein the copyback program operation is automatically performed by an internal algorithm without an external command.

8. A copyback program method of a nonvolatile memory device, the method comprising:
storing an address of a fail page included in a memory block among a plurality of memory blocks in a register, wherein the fail page is a page that has failed during a normal program operation;
reading first copyback data programmed into a first page of the fail memory block and programming the first copyback data into a first page of a target memory block other than the fail memory block among the plurality of memory blocks;
selecting a second page of the fail memory block and comparing an address of the second page and the address of the fail page stored in the register; and
if, as a result of the comparison, the address of the second page is identical to the address of the fail page, terminating a copyback program operation.

9. The copyback program method of claim 8, further comprising resetting an address of a page stored during the normal program operation as a first address, after storing the address of the fail page in the register.

10. The copyback program method of claim 8, further comprising: if, as a result of the comparison, the address of the second page differs from the address of the fail page,
reading second copyback data programmed into the second page of the fail memory block and programming the second copyback data into a second page of the target memory block; and
selecting a third page of the fail memory block and comparing an address of the third page and the address of the fail page stored in the register.

11. The copyback program method of claim 8, further comprising terminating a program operation if the fail memory block is a last memory block of the memory blocks and if the normal program operation is determined to be error, after storing the address of the fail page in the register.

12. The copyback program method of claim 8, further comprising, after programming the copyback data, performing a status check operation on the target memory block and, if, as a result of the status check operation, the normal memory block is determined to be a failure, terminating a copyback program operation.

13. The copyback program method of claim 8, wherein the copyback program operation is automatically performed by an internal algorithm without an external command.
